(19) United States
(12) Patent Application Publication
(10) Pub. No.: US 2014/0065927 A1
(43) Pub. Date: Mar. 6, 2014

(54) WEIGHTED SCALE MODEL VEHICLE

(71) Applicant: Samuel Yuehli Su, Alpine, NJ (US)

(72) Inventor: Samuel Yuehli Su, Alpine, NJ (US)

(21) Appl. No.: 13/600,759

(22) Filed: Aug. 31, 2012

(51) Int. Cl. A63H 17/26; G01G 17/00

(52) U.S. Cl. CPC A63H 17/262; G01G 17/00
USPC 446/470; 177/1

(57) ABSTRACT

A model vehicle in a first scale including a first body portion constructed of a polymer material, an undercarriage portion having a top surface and a bottom surface, the undercarriage portion and the body portion being secured to each other and defining an inner cavity therebetween, a plurality of wheels rotatably attached to the model vehicle, and a first amount of ballast disposed in the inner cavity of the model vehicle. The weight of the first amount of ballast is at least equal to the difference in weight between the weight of the first body portion and the weight of a second body portion constructed of a metal in the first scale, the first and second body portions having substantially similar outer dimensions.

### FIELD OF THE INVENTION

The present invention relates generally to model vehicles. More particularly, the present invention relates to scale model vehicles including ballast to increase their overall weight.

### BACKGROUND OF THE INVENTION

Scale models of known vehicles are extremely popular as both toys and collectables. Of the various types of scale models, such as, but not limited to, aircraft, trains, ships, spacecraft, etc., wheeled vehicles, such as cars, busses, trucks, vans, tractor trailers, motorcycles, etc., are the best known, most common, and most popular. It is known to produce such scale models from both plastics and metals, dependent largely upon the target customer and desired price range of the scale models. For example, where the scale model is intended as a children's toy, constructing the scale model primarily of plastics may be desirable. Plastics tend to be easier to work with and less costly than metals, meaning that the cost to manufacture the scale model toy should be reduced as compared to using metal. However, where the scale model is intended as a collectable for a more adult consumer, the use of metals for a large portion, if not all, of the scale model is typically more desirable than the use of plastics. Diecast metal scale models tend to have a higher perceived value amongst consumers, due largely in part to their increased weight, or “heft,” when compared to a similar plastic scale model. As well, many consumers prefer scale model toys to be constructed from metal due to the increased weight and overall impression of durability, yet are not willing to incur the increased expense of using metal as opposed to plastics for a toy.

Although, as previously noted, it is generally preferable to produce die cast scale models, both toys and collectibles, from metals, the increased cost of doing so is becoming even more pronounced than in years past. More specifically, in recent years, the metals typically used in die cast scale models, for example, zinc alloys, aluminum alloys, etc., have become increasingly more expensive to produce. As such, from the standpoint of reducing manufacturing expenses, it is desirable to produce die cast scale models from materials that are less expensive than the typical metal alloys, yet have the scale models maintain the appearance and overall feel, i.e., weight, of the same scale model were it constructed of metal. Additionally, increasing fuel prices are directly related to corresponding increases in the cost of shipping products from their point of manufacture to their ultimate destination. As such, it would be desirable to construct diecast scale models from materials that weigh less than the typical metal alloys, and subsequently add additional weight to the scale models before reaching their final destination.

### SUMMARY OF THE INVENTION

The present disclosure recognizes and addresses considerations of prior art constructions and methods. One embodiment of the present disclosure provides a model vehicle in a first scale including a first body portion constructed of a polymer material, an undercarriage portion having a top surface and a bottom surface, the undercarriage portion and the body portion being secured to each other and defining an inner cavity therebetween, a plurality of wheels rotatably attached to the model vehicle, and a first amount of ballast disposed in the inner cavity of the model vehicle. The weight of the first amount of ballast is at least equal to the difference in weight between the weight of the first body portion and the weight of a second body portion constructed of a metal in the first scale, the first and second body portions having substantially similar outer dimensions.

Another embodiment of the present disclosure provides a model vehicle in a first scale, including a first body portion constructed of a polymer material and a first amount of ballast secured to the model vehicle. The weight of the first amount of ballast is such that the overall weight of the first amount of ballast and the first body portion is at least equal to the weight of a second body portion of a second model vehicle constructed of a metal in the first scale, the first and second body portions having substantially similar outer dimensions.

Yet another embodiment of the present disclosure provides a method of adding ballast to a scale model vehicle, including weighing at least a first portion of a first scale model of a first type of vehicle constructed in a first scale, the first portion of the first scale model being constructed of a polymeric material, weighing at least a first portion of a second scale model of the first type of vehicle constructed in the first scale, the first portion of the second scale model being constructed of a metal, determining the difference in weight between the first portion of the first scale model and the first portion of the second scale model, and adding a first amount of ballast to the first scale model that is at least equal in weight to the difference in weight between the first portion of the first scale model and the first portion of the second scale model. The first portion of the first scale model and the first portion of the second scale model constitute the same portions of the respective models.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a scale model vehicle in accordance with an embodiment of the present invention;

FIG. 2 is an exploded perspective view of the scale model vehicle shown in FIG. 1;

FIG. 3 is an exploded partial perspective view of the scale model vehicle shown in FIG. 1;

FIG. 4 is an exploded partial perspective view of an alternate embodiment of a scale model vehicle in accordance with the present disclosure;

FIG. 5 is an exploded partial perspective view of an alternate embodiment of a scale model vehicle in accordance with the present disclosure;

FIG. 6 is an exploded perspective view of an alternate embodiment of a scale model vehicle in accordance with the present disclosure;

FIG. 7 is an exploded perspective view of an alternate embodiment of a scale model vehicle in accordance with the present disclosure;

FIG. 8 is an exploded partial perspective view of an alternate embodiment of a scale model vehicle in accordance with the present disclosure;

FIG. 9 is an exploded partial perspective view of an alternate embodiment of a scale model vehicle in accordance with the present disclosure; and

FIG. 9A is a partial cross-sectional view of the scale model vehicle shown in FIG. 9 along line 9A-9A.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment.

Thus, it is intended that the present invention covers such modifications and variations as come within the scope of the appended claims and their equivalents.

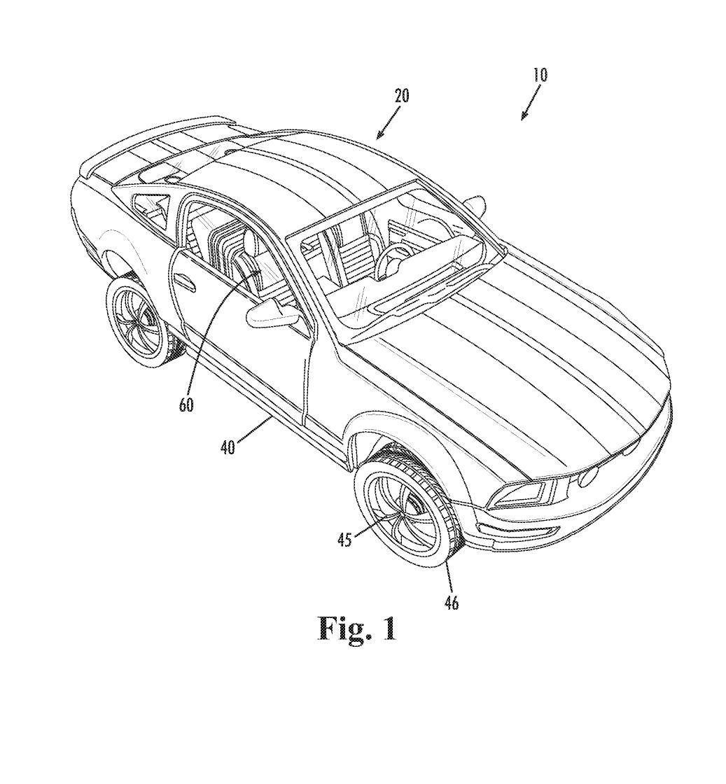

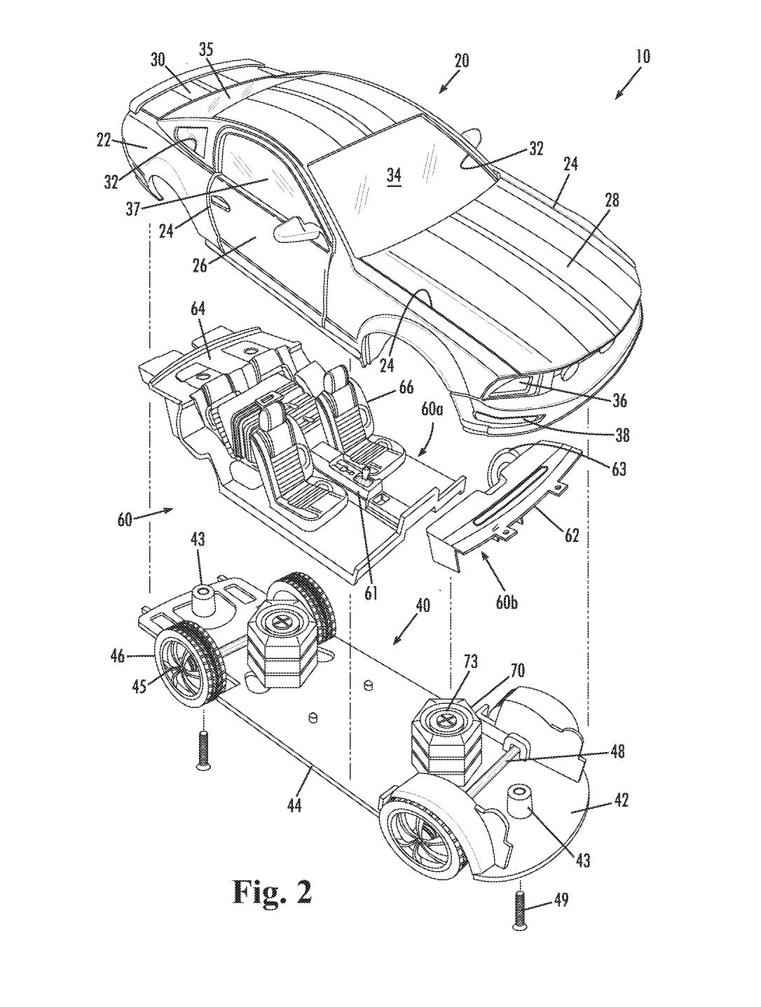

Referring now to FIGS. 1 through 3, a diecast scale model vehicle 10 in accordance with the present disclosure is shown. Scale model 10 includes a body portion 20, an undercarriage portion 40, an interior portion 60 and a set of four wheels 45. As best seen in FIG. 2, body portion 20 is removably secured to undercarriage portion 40 by a pair of threaded fasteners 49, such that body portion 20 and undercarriage portion 40 define an inner cavity therebetween. Interior portion 60, as well as a predetermined amount of ballast 70, as discussed in greater detail below, are disposed in the inner cavity defined between body portion 20 and undercarriage portion 40.

As best seen in FIG. 2, body 20 of scale model 10 includes an outer surface 22 with a plurality of recessed grooves 24 that define the doors 26, hood 28, trunk 30, and other exterior features of the scale model. In alternate embodiments, the doors 26, hood 28 and trunk lid 30 of body portion 20 may be separately manufactured and pivotably mounted to body portion 20 so that they may be opened and closed. A plurality of apertures 32 are defined by body portion 20 that allow details of interior portion 60 to be viewed, as shown in FIG. 1. A windshield 34, a rear window 35 and side windows 37 are formed by transparent plastic panels that are received in the corresponding apertures 32. Other features of scale model 10, such as headlights 36, driving lights 38, etc., may be formed integrally with body portion 20, or in the alternative, may be formed separately and affixed to body portion 20 with adhesives, a snap fit, etc. Body portion 20 is preferably diecast from a polymer material, although other materials, such as, but not limited to, rubber, Bakelite, neoprene, nylon, polystyrene, high-density polyethylene, polyethylene terephthalate, polypropylene, polyacrylonitrile, silicone, polyvinyl chloride, polyvinyl butyral, acrylonitrile butadiene styrene, ceramics, polyresins, etc., may be used. Additionally, the body portions that are constructed of non-metallic materials are preferably painted in order to present an appearance that is substantially similar in appearance to corresponding metallic body portions.

As previously noted, interior portion 60 is secured in the inner cavity. As shown, interior portion 60 includes a first portion 60a and a second portion 60b, the first portion 60a showing details such as a back deck 64, and seating 66, center console 61, etc., whereas the second portion 60b shows details of the dashboard 62, steering wheel 63, etc. Interior portion 60 may be secured to either of body portion 20 or undercarriage portion 40 prior to assembling the body portion to the undercarriage portion.

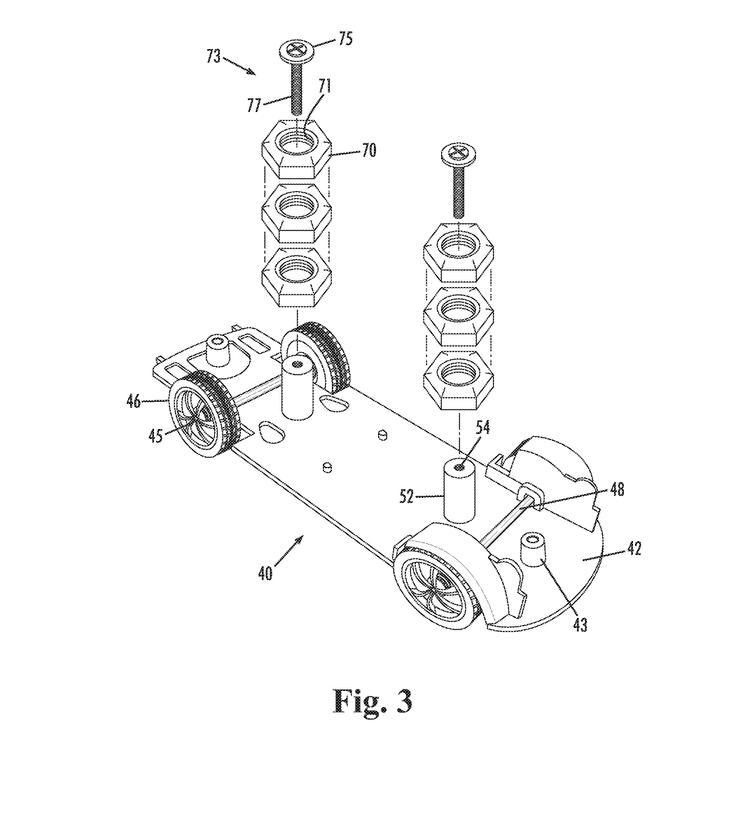

As best seen in FIGS. 2 and 3, undercarriage portion 40 includes a top surface 42 and a bottom surface 44, the bottom surface typically depicting at least some of the components, such as, but not limited to, an oil pan, suspension components, an exhaust system, etc., that would be visible when viewing the undercarriage of the full-sized vehicle which scale model 10 depicts. Additionally, a pair of mounting posts 43 depend upwardly from top surface 42 of undercarriage portion and are configured to receive a pair of threaded fasteners 49. The mounting posts 43 are disposed at opposite ends of undercarriage portion and are configured to align with a corresponding pair of threaded bores (not shown) defined by the inside surface of body portion 20. Threaded fasteners 49 extend through their corresponding mounting posts 43 and engage the threaded bores in body portion to secure the two portions together.

In the embodiment shown, a pair of posts 52 extend upwardly from, and are perpendicular to, top surface 42 of undercarriage portion 40. Each post 52 includes a cylindrical outer surface that is configured to slidably receive ballast, which in the present embodiment is constituted by a plurality of threaded nuts 70. After a desired weight of ballast is determined for addition to the scale model 10, as discussed in greater detail below, a corresponding number of threaded nuts 70 is selected, with a threaded bore 71 of each nut 70 slidably receiving the corresponding post 52. Each plurality of threaded nuts 70 is maintained in position on the corresponding post 52 by a threaded fastener 73 that engages a threaded bore 54 of the corresponding post 52 with a threaded stem 77. Note, the diameter of a head portion 75 of each threaded fastener 73 is greater than the diameter of threaded bore 71 of each nut 70, thereby maintaining each plurality of threaded nuts 70 on the corresponding post 40.

In accordance with the present disclosure, to determine the desired amount of ballast to add to a scale model 10 including a polymer body portion 20, a specific scale model vehicle is first selected. For example, FIGS. 1 through 3 show a scale model 10 of a 2006 Ford Mustang, including a body portion 20 constructed of a non-metallic material, preferably a polymer material. Next, another scale model, constructed to the same scale, is selected for the same make, model and year vehicle. In short, the two scale models are of the same scale and depict the same vehicle. However, the second scale model includes a body portion 20 constructed of a metal, such as a zinc alloy, an aluminum alloy, or alloy containing zinc, copper, magnesium, iron, lead, etc. Next, the weight of the scale model with a polymer body portion 20 is determined, as well as the weight of the scale model vehicle with the metal body portion. An amount of ballast is selected that is at least equal to the difference in weight between the model car having the polymer body portion 20 and the model car having the metal body portion. The additional ballast, represented by threaded nuts 70 in FIGS. 1 through 3, is then secured to the scale model 10 having a polymer body portion 20. As such, the scale model 10 with the polymer body portion 20 weighs at least as much as the scale model including the metal body portion. Preferably, the additional ballast is secured to scale model 10 in such a manner that the ballast is not visible once scale model 10 is fully assembled. As shown in FIGS. 1 through 3, the ballast, or threaded nuts 70, are secured to undercarriage 40 in a manner that they are concealed by first portion 60a and second portion 60b of interior portion 60 when scale model 10 is fully assembled. Alternately, rather than weighing both scale models in their entireties, the desired amount of ballast can be determined by weighing only the body portions. More specifically, the body portions can be removed from the corresponding scale models and weighed independently.

Note, although it is desirable that the amount of ballast is selected such that scale model vehicle 10 including a polymer body portion 20 weighs at least as much as the scale model with a metal body portion, it may also be desirable to have scale model 10 weigh up to twice as much as the scale model vehicle including a body portion constructed of metal. However, it is most preferable for the scale model 10 with a polymer body portion 20 to weigh 10% to 50% more than the scale model with a body portion constructed of metal, most preferably weighing between 20% to 40% more.

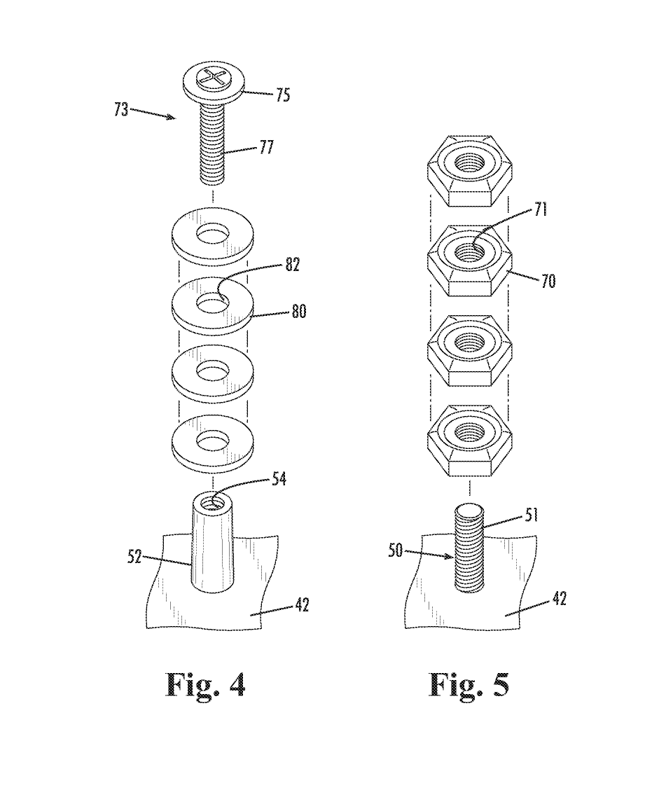

Referring now to FIG. 4, an alternate method of adding ballast to a scale model vehicle is shown. The method depicted in FIG. 4 differs only from that shown in FIGS. 1 through 3 in that threaded nuts 70 have been replaced by a plurality of disc-shaped washers 80 that define unthreaded center bores 82. Referring additionally to FIG. 5, yet another alternate method of adding ballast to a scale model is shown. The method shown in FIG. 5 differs only from that method shown in FIGS. 1 through 3 in that post 52 has been replaced by a post 50 which includes an externally threaded surface 51. As such, threaded nuts 70 can be directly threaded onto post 50 and there is no need for threaded fastener 73, as shown in FIGS. 1 through 3.

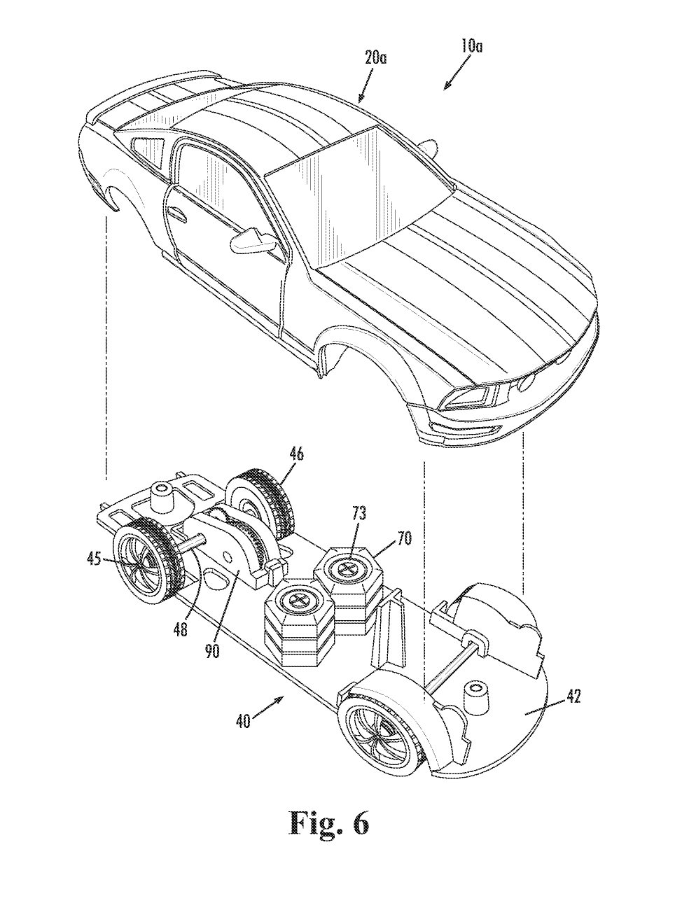

Referring now to FIG. 6, an alternate embodiment of a scale model vehicle 10a is shown. Scale model 10a differs primarily from scale model 10 shown in FIGS. 1 through 3 in that body portion 20a does not define apertures 32 through which the inner cavity of scale model 10a can be viewed. As such, the ballast, or threaded nuts 70, can be positioned on undercarriage 40 wherever it is most convenient. Additionally, scale mode 10a includes a wind-up mechanism 90 that is in driving engagement with rear axial 48 for propelling model vehicle 10a in the forward direction.

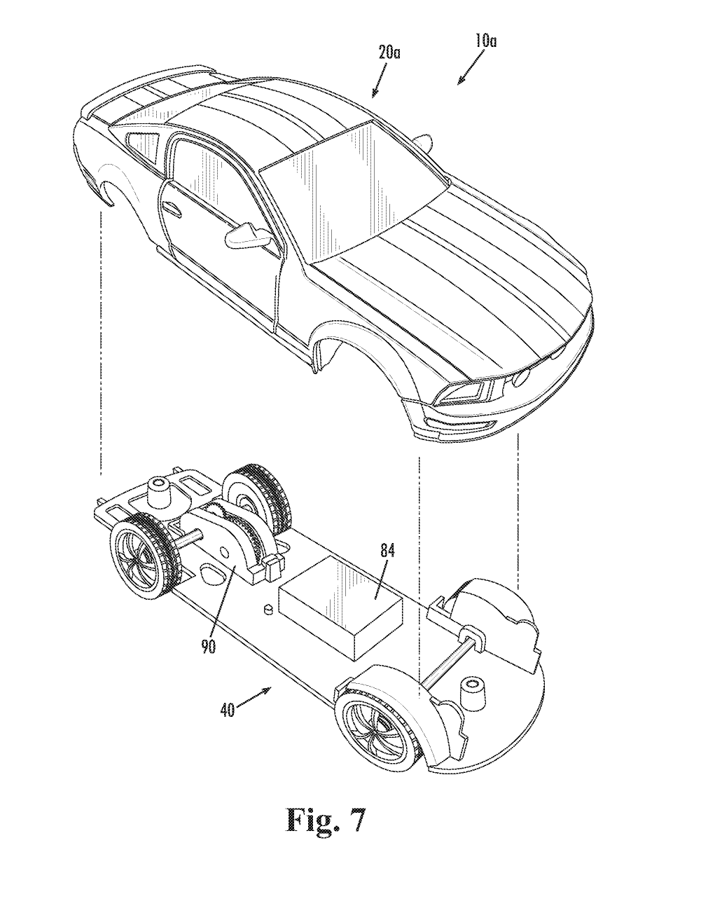

Referring now to FIG. 7, ballast in the form of a rectangular slug 84 is adhesively secured to top surface 42 of undercarriage 40. Although slug 84 is preferably formed from metal, it may also be formed by other materials, such as, but not limited to, resins, plastics, ceramics, etc.

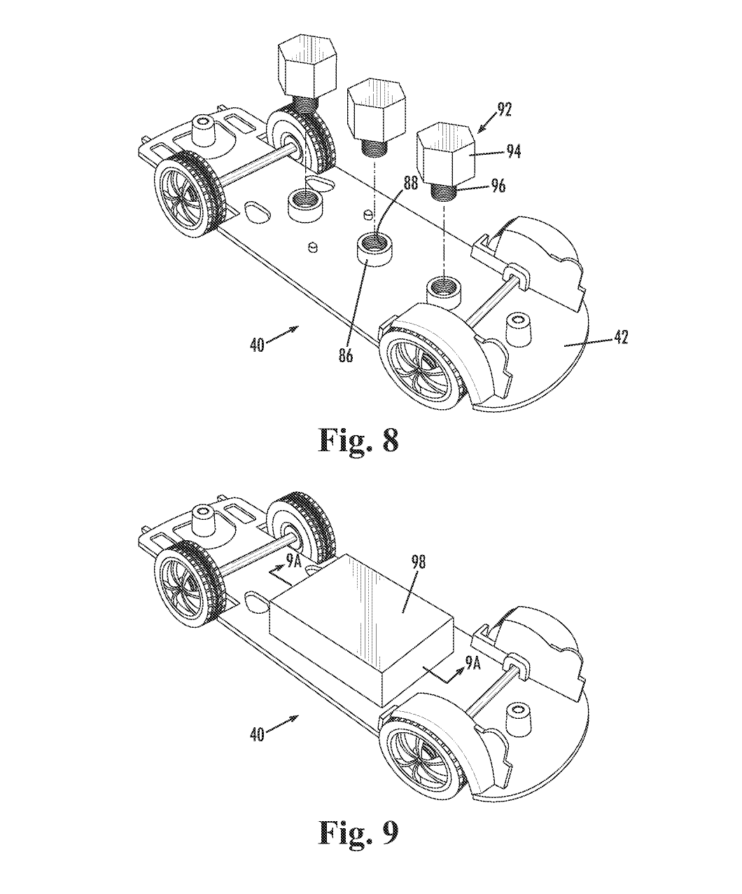

Referring now to FIG. 8, ballast in the form of threaded bolts is secured to undercarriage 40. As shown, each bolt 92 includes a head 94 and a threaded stem 96 that engages a corresponding threaded bore 88 defined by a corresponding post 86 that extends upwardly from top surface 42 of undercarriage 40. Although multiple posts 86 may be provided on undercarriage 40, it is not necessary that each be utilized to receive a threaded bolt, dependent upon the desired amount of ballast.

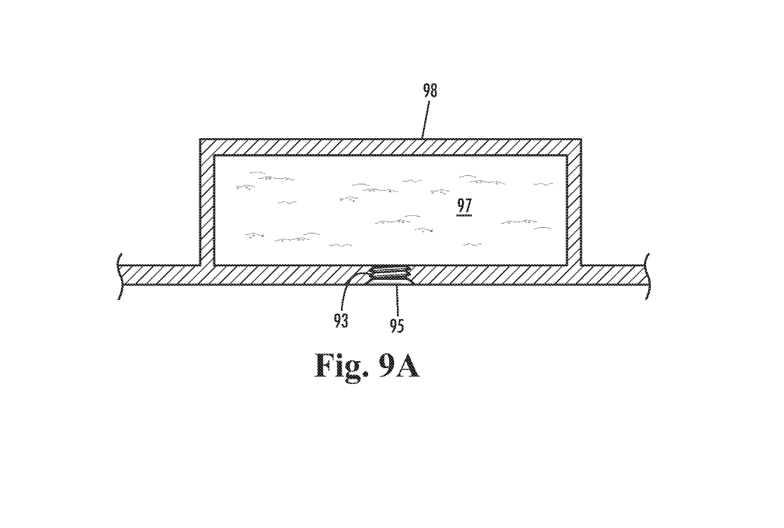

Referring now to FIGS. 9 and 9A, a ballast cavity 98 is provided on undercarriage 40. As best seen in FIG. 9A, ballast cavity 98 includes a threaded bore 93 to allow access to the cavity, and a threaded plug 95 is used to seal the cavity once filled. Ballast cavity 98 is accessible from bottom side 44 of undercarriage 40 through threaded bore 93. As such, it is possible to access ballast cavity 98 without having to remove body portion 20 from undercarriage portion 40, meaning ballast may be added to the corresponding scale model vehicle after it has been full assembled. Ballast 97, such as, but not limited to, purified water, sand, metal filings, etc., can be added ballast cavity 98 and maintained therein by sealing ballast cavity 98 with threaded plug 95. Preferably, threaded plug 95 is sealed in position with additional adhesives, so as to prevent inadvertent opening of ballast cavity 98.

While one or more preferred embodiments of the invention are described above, it should be appreciated by those skilled in the art that various modifications and variations can be made in the present invention without departing from the scope and spirit thereof. For example, alternate methods of weighting, types of ballast, etc., can be used to weight model scale vehicles. It is intended that the present invention cover such modifications and variations as come within the scope and spirit of the appended claims and their equivalents.

What is claimed is:

1. A model vehicle in a first scale, comprising:
a first body portion constructed of a polymer material;
an undercarriage portion having a top surface and a bottom surface, the undercarriage portion and the body portion being secured to each other and defining an inner cavity therebetween;
a plurality of wheels rotatably attached to the model vehicle; and
a first amount of ballast disposed in the inner cavity of the model vehicle,
wherein the weight of the first amount of ballast is at least equal to the difference in weight between the weight of the first body portion and the weight of a second body portion constructed of a metal in the first scale, the first and second body portions having substantially similar outer dimensions.

2. The model vehicle of claim 1, wherein the second body portion is constructed from one of a zinc alloy and an aluminum alloy.

3. The model vehicle of claim 1, wherein the plurality of wheels further comprises four wheels and each of the four wheels is attached to the undercarriage portion.

4. The model vehicle of claim 1, wherein the overall weight of the first amount of ballast and the first body portion is 5% to 35% greater than the weight of the second body portion.

5. The model vehicle of claim 1, wherein the overall weight of the first amount of ballast and the first body portion is 10% to 30% greater than the weight of the second body portion.

6. The model vehicle of claim 1, wherein the first body portion defines apertures configured to allow a user to view a portion of the inner cavity.

7. The model vehicle of claim 6, further defining an interior portion disposed within the inner cavity, wherein portions of the interior portion, the body portion and the undercarriage portion define a first cavity in which the first amount of ballast is disposed.

8. The model vehicle of claim 1, wherein the undercarriage portion further defines a first post depending upwardly therefrom, and the first amount of ballast further comprises at least one nut defining a threaded bore, the first post extending through the threaded bore.

9. The model vehicle of claim 8, wherein an outer cylindrical surface of the first post is correspondingly threaded to the threaded bore of the at least one nut such that the at least one nut is received thereon by engaging the corresponding threads of the first post.

10. The model vehicle of claim 1, further comprising a drive mechanism adapted to propel the model vehicle, the drive mechanism being disposed in the inner cavity.

11. A model vehicle in a first scale, comprising:
a first body portion constructed of a polymer material; and
a first amount of ballast secured to the model vehicle,
wherein the weight of the first amount of ballast is such that the overall weight of the first amount of ballast and the first body portion is at least equal to the weight of a second body portion of a second model vehicle constructed of a metal in the first scale, the first and second body portions having substantially similar outer dimensions.

12. The model vehicle of claim 11, wherein the second body portion is constructed from one of a zinc alloy and an aluminum alloy.

13. The model vehicle of claim 11, further comprising an undercarriage portion having a top surface and a bottom surface, the undercarriage portion and the body portion being secured to each other and defining an inner cavity therebetween.

14. The model vehicle of claim 13, further comprising a plurality of wheels attached to the undercarriage portion.

15. The model vehicle of claim 11, wherein the weight of the first amount of ballast is such that the weight of the first amount of ballast and the first body portion is at least twice the weight of the second body portion of the second model vehicle.

16. The model vehicle of claim 11, wherein the overall weight of the first amount of ballast and the first body portion is 10% to 50% greater than the weight of the second body portion of the second model vehicle.

17. A method of adding ballast to a scale model vehicle, comprising:
weighing at least a first portion of a first scale model of a first type of vehicle constructed in a first scale, the first portion of the first scale model being constructed of a polymeric material;
weighing at least a first portion of a second scale model of the first type of vehicle constructed in the first scale, the first portion of the second scale model being constructed of a metal;
determining the difference in weight between the first portion of the first scale model and the first portion of the second scale model; and
adding a first amount of ballast to the first scale model that is at least equal in weight to the difference in weight between the first portion of the first scale model and the first portion of the second scale model,
wherein the first portion of the first scale model and the first portion of the second scale model constitute the same portions of the respective models.

18. The method of claim 17, wherein the first portion of the first scale model constitutes the entire first scale model and the first portion of the second scale model constitutes the entire second scale model.

19. The method of claim 18, wherein the combined weight of the first scale model and the first amount of ballast is 10% to 50% greater than the weight of the second scale model.

20. The method of claim 18, wherein the combined weight of the first scale model and the first amount of ballast is 100% greater than the weight of the second scale model.

21. The method of claim 17, wherein the metal of the first portion of the second scale model further comprises one of a zinc alloy and an aluminum alloy.

22. The method of claim 17, wherein the first scale model further comprises a body portion and an undercarriage portion, and the body portion further comprises the first portion of the first scale model, and the second scale model further comprises a body portion and an undercarriage portion, and the body portion further comprises the first portion of the second scale model.

23. A model vehicle in a first scale, comprising:
a first body portion constructed of a non-metallic material; and
a first amount of ballast secured to the model vehicle,
wherein the weight of the first amount of ballast is such that the overall weight of the first amount of ballast and the first body portion is at least equal to the weight of a second body portion of a second model vehicle constructed of a metal in the first scale, the first and second body portions having substantially similar outer dimensions.

24. The model vehicle of claim 23 wherein the second body portion is constructed from one of a zinc alloy and an aluminum alloy.

25. The model vehicle of claim 23, wherein the overall weight of the first amount of ballast and the first body portion is 10% to 50% greater than the weight of the second body portion of the second model vehicle.
